(19) United States
(12) Patent Application Publication
(10) Pub. No.: US 2015/0001242 A1
(43) Pub. Date: Jan. 1, 2015

(54) VENDING MACHINE

(71) Applicants: HONG FU JIN PRECISION INDUSTRY (WUHAN) CO., LTD., Wuhan (CN); HON HAI PRECISION INDUSTRY CO., LTD., New Taipei (TW)

(72) Inventors: YUN-LUNG CHEN, New Taipei (TW); LI TONG, Wuhan (CN); WEI-YONG MA, Wuhan (CN); REN-XI DOU, Wuhan (CN); LIANG TU, Wuhan (CN); ZHI-WU XIA, Wuhan (CN)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 14/267,021

(22) Filed: May 1, 2014

(30) Foreign Application Priority Data
Jun. 26, 2013 (CN) 2013102588066

(51) Int. Cl. G07F 11/02

(52) U.S. Cl. CPC G07F 11/02
USPC 221/133

(57) ABSTRACT

A vending machine allowing only one compartment at a time to be filled with goods for sale includes a rack, a plurality of warehouses, a limiting band or rope. The plurality of warehouses is slidably accommodated in the rack. The band or rope is rotatably secured to the rack and engages with each of the plurality of warehouses. The band or rope is stretched to the full when one of the plurality of warehouses is pulled out of the rack, preventing any other warehouse from being pulled out of the rack at the same time.

### FIELD

The present disclosure generally relates to a vending machine.

### BACKGROUND

A vending machine usually includes a rack and a plurality of warehouses. The plurality of warehouses is vertically installed on the rack, for being loaded with a variety of goods, such as snacks, beverages, alcohol, cigarettes, lottery tickets, cologne, consumer products and even gold and gems. When goods are loaded by the merchant however, two or more of the plurality of warehouses may be pulled out of the rack to be filled with goods at the same time, and the rack may topple and fall due to gravity as the two or more warehouses are pulled out.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of an embodiment of a vending machine.

FIG. 2 is an enlarged view of circled portion II of the wending machine of FIG. 1.

FIG. 3 is an isometric view of a warehouse and a sliding way of FIG. 1.

FIG. 4 is an isometric view of a limiting structure of FIG. 1.

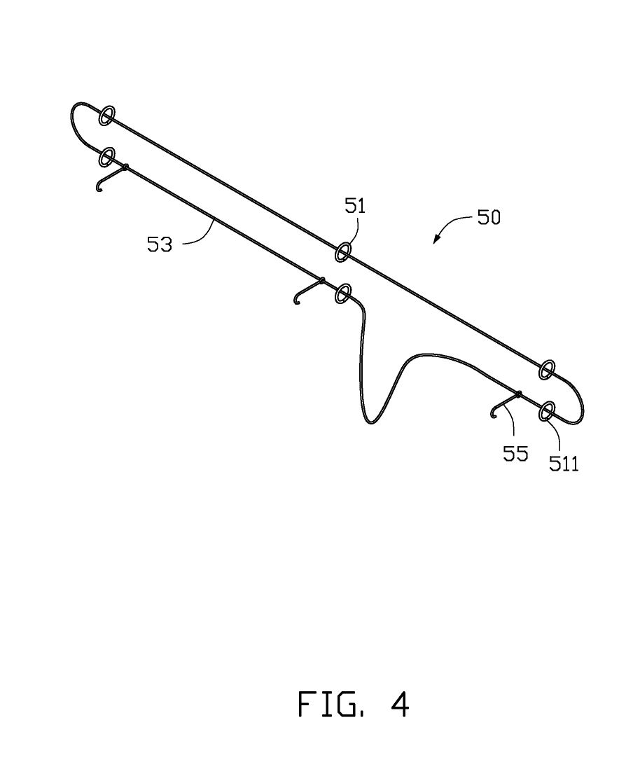

FIG. 5 is an assembled view of the vending machine of FIG. 1, one of the plurality of warehouses being in a retracted position.

FIG. 6 is an assembled view of the vending machine of FIG. 1, and one of the plurality of warehouses being in a stretched-out position.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

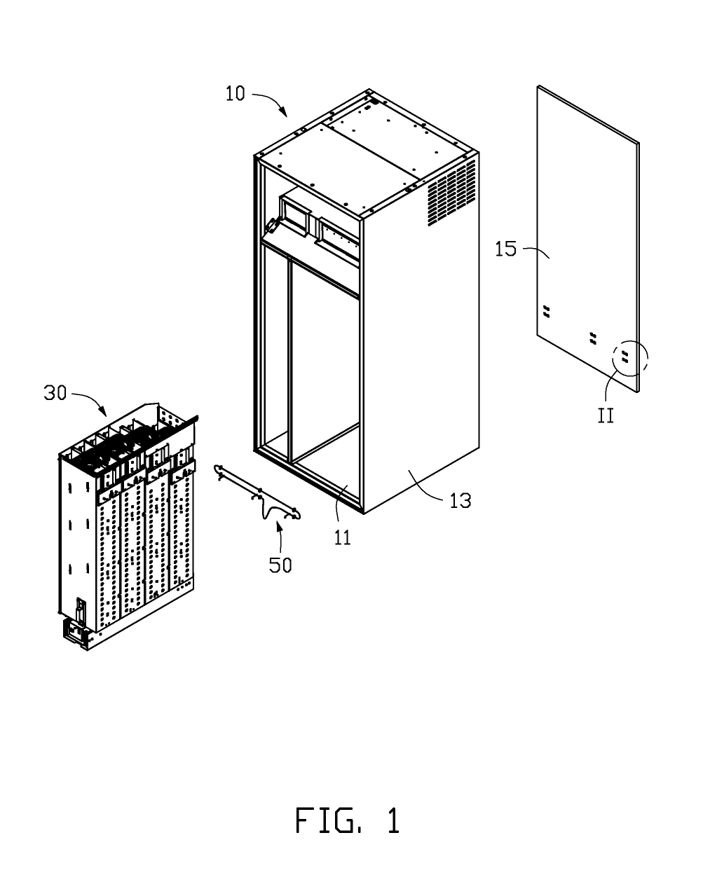

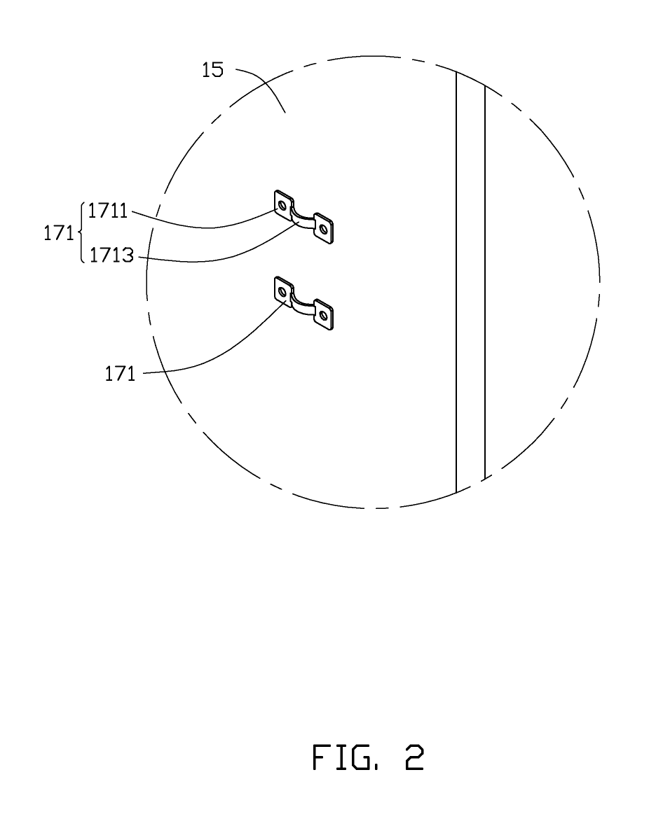

FIGS. 1 and 2 illustrate an embodiment of a vending machine. The vending machine includes a rack 10, a plurality of warehouses 30, and a limiting structure 50 installed on the rack 10. The plurality of warehouses 30 can accommodate a plurality of goods, such as snacks, beverages, alcohol, cigarettes, lottery tickets, cologne, consumer products, and gold and gems.

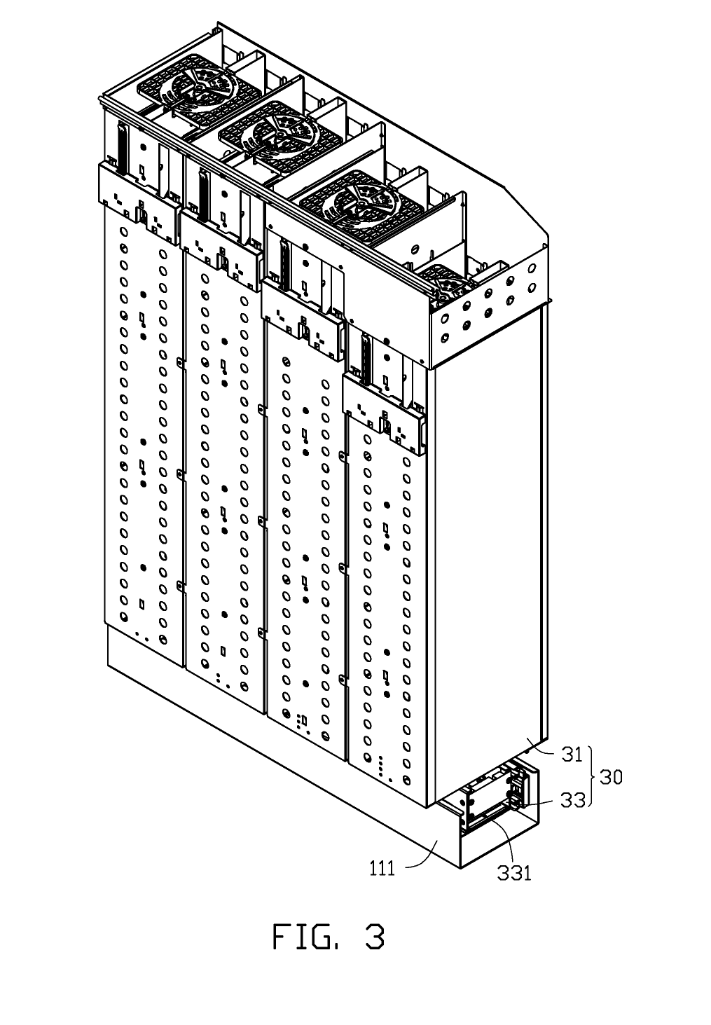

The rack 10 includes a bottom plate 11, two side plates 13, and a rear plate 15. The two side plates 13 are located on opposite sides of the bottom plate 11, and the rear plate 15 is installed on the bottom plate 11 and is connected to the two side plates 13. A plurality of sliding ways 111 (shown in FIG. 3) is installed on the bottom plate 11 in parallel. Each of the plurality of warehouses 30 is slidably engaged with each of plurality of sliding ways 111.

A plurality of securing pieces 171 is located on the rear plate 15. In one embodiment, there are six securing pieces 171, and the six securing members 171 are arranged in a rectangle. Each of the plurality of securing pieces 117 includes two securing tabs 1711 and a bridge portion 1713 connected to the securing tabs 1711. The two securing tabs 1711 are secured to the rear plate 15 in a well known way, such as by soldering or screwing. In one embodiment, four of the plurality of securing pieces 171 is arranged at corners of the rectangle, and the other of the plurality of securing pieces 171 are arranged at two opposite edges of the rectangle.

FIG. 3 illustrates that each of the plurality of warehouses 30 includes a body 31 and a latching board 33 installed on the body 31. The latching board 33 defines a latching hole 331 corresponding to the limiting structure 50.

FIG. 2 illustrates that the limiting structure 50 includes a plurality of rings 51, a rope 53, and a plurality of hooks 55. The number of the plurality of securing pieces 171 is the same as the number of rings 51, and the number of the plurality of hooks 55 is the same as the number of warehouses 30. Each of the plurality of rings 51 defines a cutout 511 for each of the plurality of rings 51 to snap onto the rope 53. Each of the plurality of hooks 55 is sleeved on the rope 53. In one embodiment, the rope 53 is joined end to end to function as an endless rope.

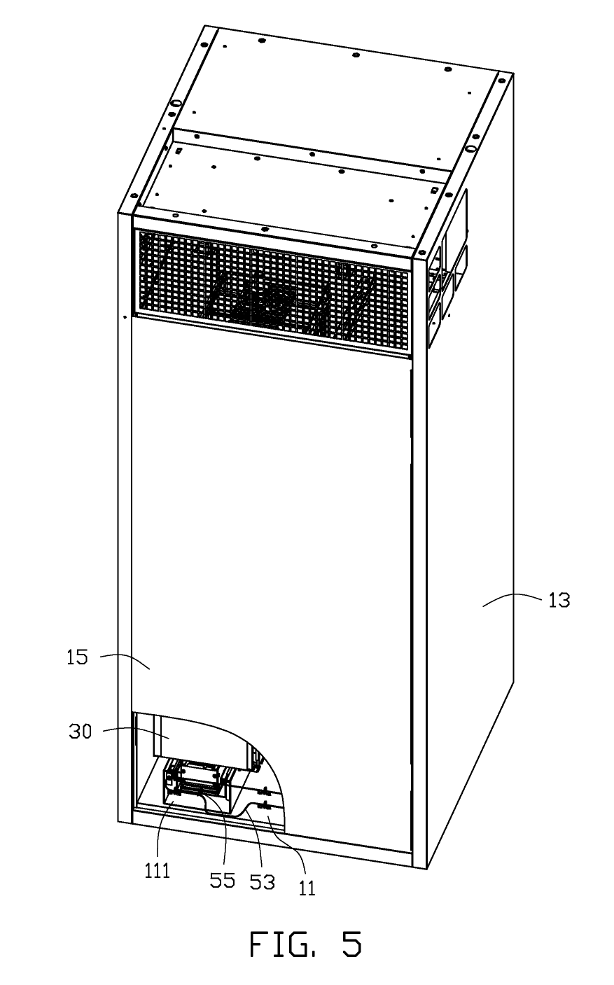

FIG. 5 illustrates that, in assembly of the limiting structure 50, each of the plurality of rings 51 is sleeved on the bridge portion 1713 of each of the plurality of securing pieces 171. The rope 53 is thereby rotatably suspended on the rear plate 15 by the plurality of rings 51. Each of the plurality of hook 55 is engaged in the latching hole 331 of each of the plurality of warehouses 30, and the rope 53 is thereby located on the back of the plurality of warehouses 30.

When goods are to be supplied, one of the plurality of warehouses 30 is pulled out. One of the plurality of warehouses 30 slides far away from the rear plate 15 to stretch the rope 53, until the one of the plurality of warehouses 30 is located in a stretched-out position, where the one of the plurality of warehouses 30 is out of the rack 10, and the rope 53 is under tension preventing this one of the plurality of warehouses 30 from completely disengaging from the rack 10 and blocking the other warehouses 30 from being pulled out of the rack 30. The other of the plurality of warehouses 30 are slidable until the stretched-out one of the plurality of warehouses 30 is pushed back into the rack 10. Therefore, only one of the plurality of warehouses 30 can be pulled out of the rack 30 at a time to prevent the rack 10 from toppling and falling.

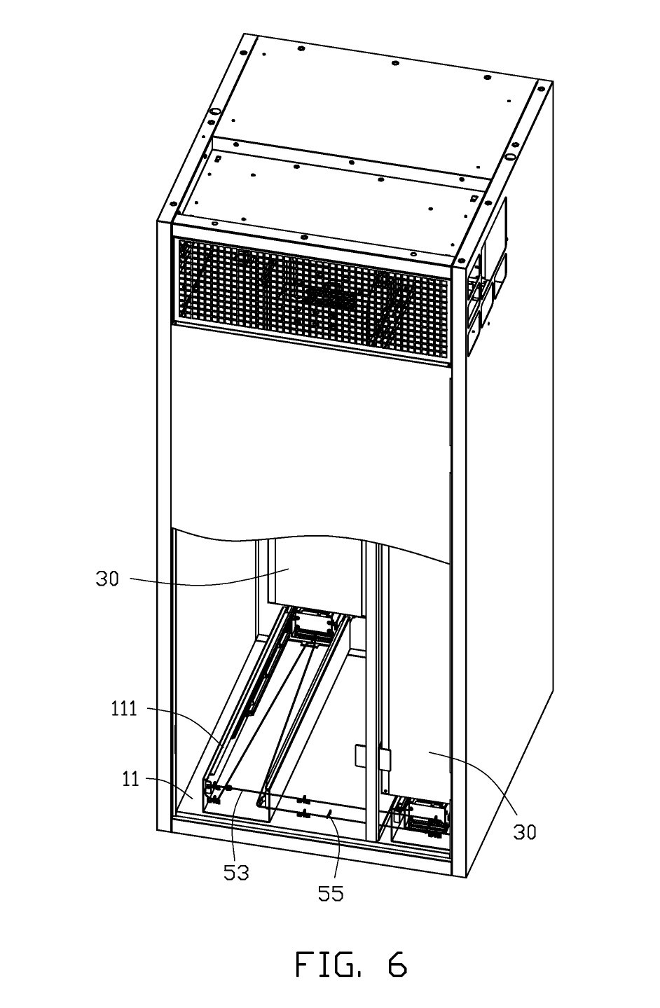

After the stretched-out one of the plurality of warehouses 30 is filled with goods, that one of plurality of warehouses 30 is pushed back into the rack 10 and thus in a retracted position, and the rope 53 is again slack (shown in FIG. 6).

It is to be understood, however, that even though numerous characteristics and advantages have been set forth in the foregoing description of embodiments, together with details of the structures and functions of the embodiments, the disclosure is illustrative only and changes may be made in detail, including matters of shape, size, and arrangement of parts within the principles of the disclosure. The embodiments described herein are illustrative, and are not intended to limit the scope of the following claims.

What is claimed is:

1. A vending machine comprising:
a rack;
a plurality of warehouses slidably accommodated in the rack; and
a limiting structure movably secured to the rack and engaged with each of the plurality of warehouses;
wherein the limiting structure is under tension when one of the plurality of warehouses is pulled out of the rack and the limiting structure is drawn by the one of the plurality of warehouses, thereby preventing the one of the plurality of warehouses from disengaging from the rack and the other of the plurality of warehouses from being pulled out of the rack.

2. The vending machine of claim 1, wherein the rack comprises a rear plate, the limiting structure comprises a rope, and the rope is movably suspended on the rear plate.

3. The vending machine of claim 2, wherein a plurality of securing pieces is located on the rear plate, the limiting structure further comprises a plurality of rings sleeved on the rope, and each of the plurality of rings is secured to each of the plurality of securing pieces.

4. The vending machine of claim 3, wherein each of the plurality of securing pieces comprises two securing tabs and a bridge portion connected to the two securing tab, and each of the plurality of rings is sleeved on the bridge portion of each of the plurality of securing pieces.

5. The vending machine of claim 2, wherein the limiting structure further comprises a plurality of hooks sleeved on the rope, and each of the plurality of hooks is engaged with each of the plurality of warehouses.

6. The vending machine of claim 2, wherein the rack further comprises a bottom plate connected to the rear plate, a plurality of sliding ways is located on the bottom plate, and each of the plurality of warehouses is slidably engaged in each of the plurality of sliding ways.

7. The vending machine of claim 6, wherein a length of rope is greater than a length of each of the plurality of sliding ways.

8. The vending machine of claim 3, wherein each of the plurality of rings defines a cutout, and the rope is snapped in each of the plurality of rings by the cutout.

9. A vending machine comprising:
a rack comprising a rear plate;
a plurality of warehouses slidably accommodated in the rack; and
a limiting structure movably secured to the rear plate and engaged with each of the plurality of warehouses;
wherein one of the plurality of warehouses is slidable relative to the rack between a stretched-out position and a retracted position, when the one of the plurality of warehouses is located in the stretched-out position, the one of plurality of the warehouses is moved out of the rack, and the limiting structure is tension, to prevent the one of the plurality of warehouses from disengaging from the rack and the other of the plurality of warehouses from being pulled out of the rack; when the one of the plurality of warehouses is located in the retracted position, the one of the plurality of warehouses is received in the rack, and the limiting structure is slack, to disengage the other of the plurality of warehouses from the rack.

10. The vending machine of claim 9, wherein the limiting structure comprises a rope, and the rope is movably suspended on the rear plate.

11. The vending machine of claim 10, wherein a plurality of securing pieces is located on the rear plate, the limiting structure further comprises a plurality of rings sleeved on the rope, and each of the plurality of rings is secured to each of the plurality of securing pieces.

12. The vending machine of claim 11, wherein each of the plurality of securing pieces comprises two securing tabs and a bridge portion connected to the two securing tab, and each of the plurality of rings is sleeved on the bridge portion of each of the plurality of securing pieces.

13. The vending machine of claim 11, wherein the limiting structure further comprises a plurality of hooks sleeved on the rope, and each of the plurality of hooks is engaged with each of the plurality of warehouses.

14. The vending machine of claim 11, wherein the rack further comprises a bottom plate connected to the rear plate, a plurality of sliding ways is located on the bottom plate, and each of the plurality of warehouses is slidably engaged in each of the plurality of sliding ways.

15. The vending machine of claim 14, wherein a length of rope is greater than a length of each of the plurality of sliding ways.

16. The vending machine of claim 11, wherein four of the plurality of securing pieces are arranged at four corners of a rectangle, and the other of the plurality of securing pieces are arranges at two opposite edges of the rectangle.

17. The vending machine of claim 12, wherein each of the plurality of rings defines a cutout, and the rope is snapped in each of the plurality of rings by the cutout.

18. The vending machine of claim 10, wherein the rope is joined end to end to form a loop.
